(19) United States
(12) Patent Application Publication
(10) Pub. No.: US 2007/0046653 A1
(43) Pub. Date: Mar. 1, 2007

(54) Digital pen methods and apparatus for healthcare systems

(75) Inventors: Charles J. Halfpenny JR., Audubon, PA (US); Curtis Zeberlein, Langhorne, PA (US); Melvin Todd Eddy, Collegeville, PA (US)

Correspondence Address: JOSEPH E. CHOVANES, SUITE 329, 5 GREAT VALLEY PARKWAY, MALVERN, PA, 19355, US

(73) Assignee: HALFPENNY TECHNOLOGIES, INC.

(21) Appl. No.: 11/217,766

(22) Filed: Sep. 1, 2005

(51) Int. Cl. G09G 5/00

(52) U.S. Cl. 345/179

(57) ABSTRACT

Digital pen methods and apparatus for healthcare systems are shown. A digital pen is used with a form which then will be interpreted. Various actions may take place as a result. User interaction may include verification and error handling.

### FIELD OF THE DISCLOSURE

The present disclosure is related to digital pen methods and apparatus for healthcare systems. More particularly, the present disclosure is related to digital pen methods and apparatus for healthcare paper based systems.

### BACKGROUND OF THE DISCLOSURE

Healthcare systems, such as those involved in laboratory tests, hospital orders, and physician offices, involve large amounts of paper based forms. Although computerization has made incursions in almost every industry, many healthcare systems and practices are still based upon using paper based forms.

For example, physicians may still order patient tests from laboratories on paper based forms, which must be read, collected, copied, filed, etc. The sheer inefficiency of each of these practices, and others in the healthcare industry involving paper based forms, increases costs of the industry. For example, the forms usually must be collected, read, be key punched into computer systems, copies maintained in various locations, etc. Moreover, errors may arise in any of the steps of any system or practice where paper based forms are used. Privacy concerns, arising from practices and regulations concerning unauthorized dissemination of information, have lately emerged as well.

### BRIEF DESCRIPTION OF THE DRAWINGS

FIG. 1 shows a view of a preferred embodiment.

FIG. 2 shows a view of a preferred embodiment.

FIG. 3 shows a view of a preferred embodiment.

FIG. 4 shows a view of a preferred embodiment.

FIG. 5 shows a view of a preferred embodiment.

### DETAILED DESCRIPTION OF THE PREFERRED EMBODIMENTS

The present preferred embodiments provide digital pen methods and apparatus for healthcare systems. The details of one or more embodiments of the invention are set forth in the accompanying drawings and the description below. Other features, objects, and advantages of the invention will be apparent from the description and drawings, and from the claims.

Embodiments may replace various paper based forms in healthcare practice. For example, preferred embodiments may include diagnostic services, including but not limited to physician ordering of laboratory services, radiology services, ultrasound services, pharmacy services, pathology services and other services ordered by a physician, ABN, inter- and intra-office communications, etc.

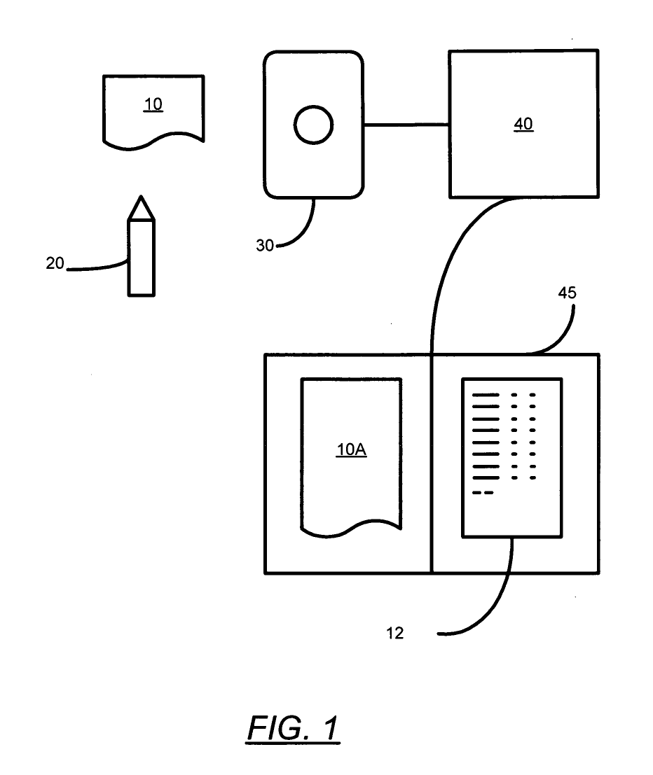

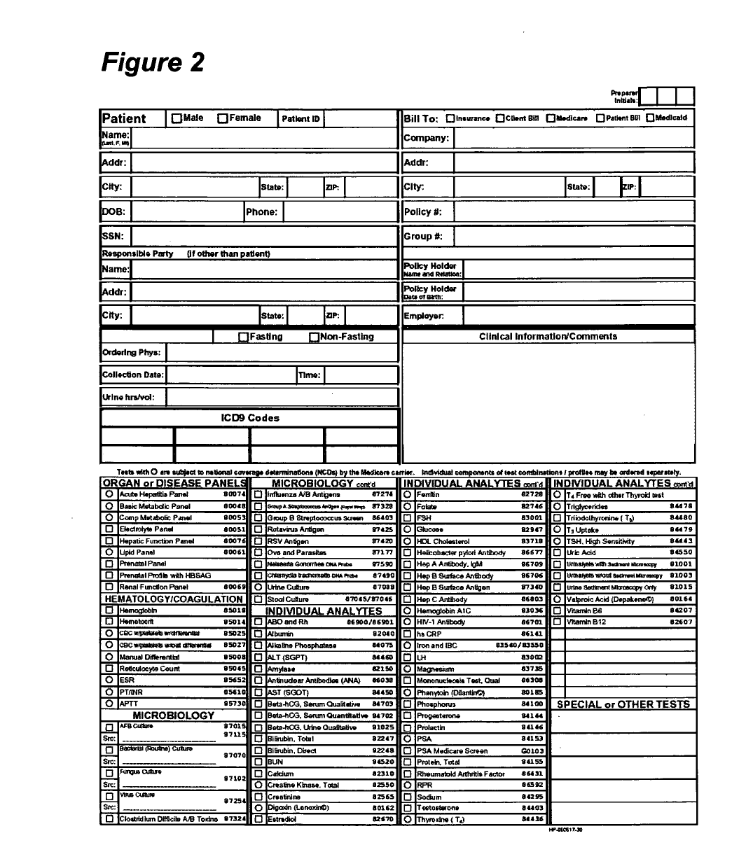

Turning now to FIG. 1, a schematic diagram of an embodiment is shown. Form 10, is in this embodiment is a laboratory requisition form, used to order tests for a patient by a doctor's office. Form 10 is similar to traditional forms as are known in the art, that is, it is printed with various fields, including patient information, tests to be ordered, etc. Turning briefly to FIG. 2, an embodiment of a form is seen.

Returning to FIG. 1, pen 20 is used to fill out form 10. Aside from standard writing capabilities, e.g., ball point, felt tip, etc., pen 20 is capable of recording the information it is writing on form 10. Pen 20 is fitted with a pressure sensor and camera (not shown.) The pressure sensor identifies when pen 20 is pressed to a surface. The camera takes pictures on a regular schedule (e.g., 60 per minute) of the markings as they are made among the dots on form 10. Thus, any markings and the position of any markings made by pen 10 can be recorded. In preferred embodiments, the pen 20 is made by Logitech under the trademark Logitech IO Digital Pen and form 10 is printed on paper using Anoto technology.

Pen 20 is then placed into dock 30 which is connected to CPU 40. Marking information generated from using pen 20 on form 10 is downloaded through dock 30 to CPU 40. The results of the pen's use and scan—the markings—are then reproduced through the positional software on screen 45, as an electronic copy of form 10, identified in the figure as 10A.

Any data desired to be recognized from the form is also shown on screen 45, in split screen view. So for example, if a patient's name, address and five tests of varying nature have been written on original form 10, the same writing is shown on form 10A. Recognized data (for example, the patient's name, address and tests ordered) are shown next to form 10A in data entry screen 12.

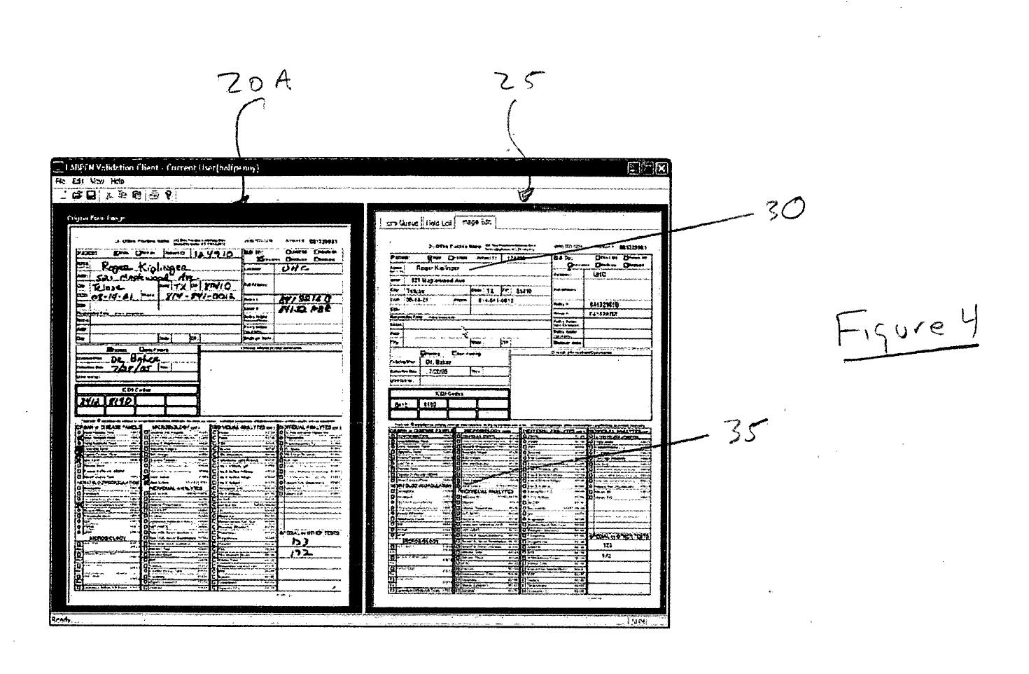

Turning briefly to FIG. 4, an example of such a split screen is shown. An electronic copy of the original form is shown at 20A and a data entry screen, comprised of the markings made on the original form, is shown at 25. As can be seen, the handwriting identifying the patient's name has been recognized (30) as well as the various tick marks denoting tests to be performed (35.) Although not shown in the figure, notification may be provided that errors exist in recognition, e.g., the handwritten address meant to be recognized is not recognized. As is further described below, various methods may be used in various embodiments for error correction.

As will be further described below, various embodiments provide various alternatives once form 10 is marked, the information from pen 20 downloaded, the electronic copy of form 10 (for example form 10A) created, and data recognized.

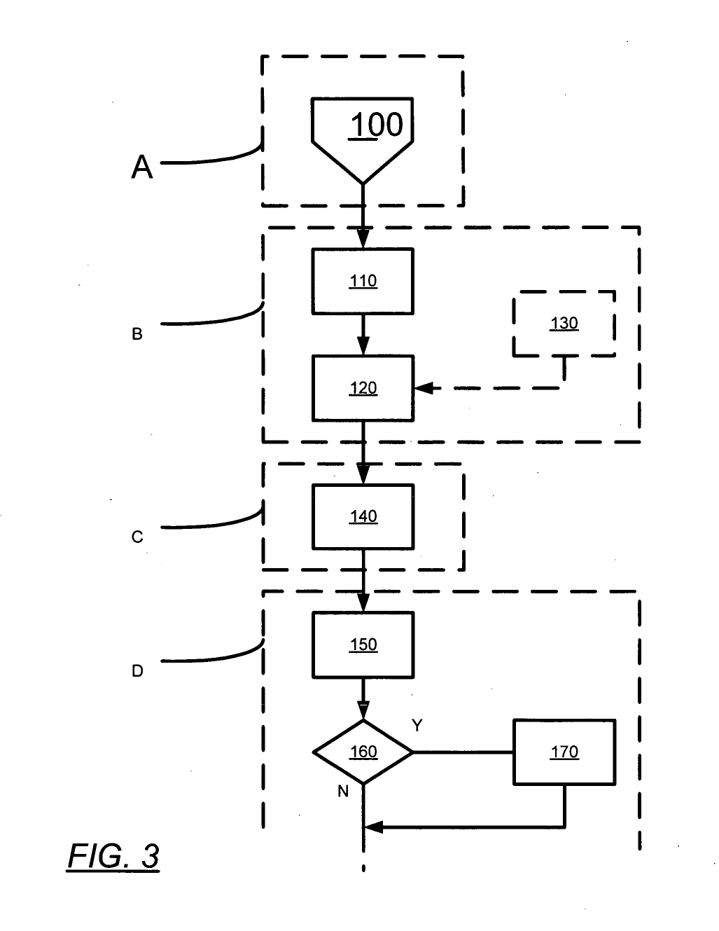

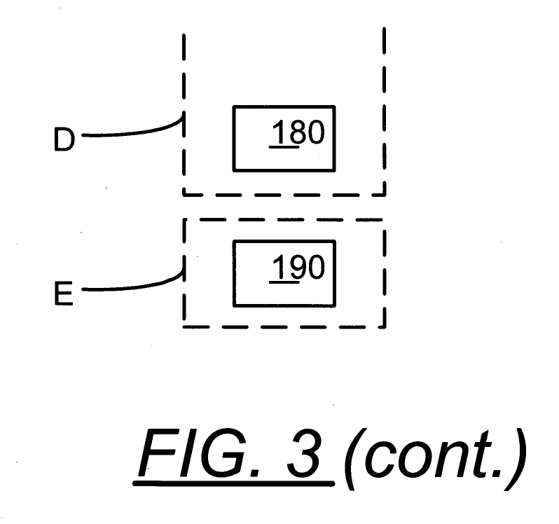

Turning now to FIG. 3, a flow chart is shown of a preferred embodiment. An Acquisition phase is first seen, generally at A. A form is filled out with a digital pen at 100. “Digital pen” is used herein to describe any suitable pen capable of being used to electronically create data that copies, in whole or part, markings made by the pen on media. In preferred embodiments, as was described above, a Logitech-Anoto pen and paper is used. It should be noted however that any suitable device may be used. For example, Nokia presently provides a digital pen. Generally, Anoto technology is used in preferred embodiments, which may be available from various vendors as Anoto licensees.

Returning to FIG. 3, an Interpretation phase is seen generally at B. At 110, any data stored in 100 is downloaded to a data capture device. This data capture device may be any suitable device, e.g., memory, CPU, flash memory, etc. It may also be desired, in other embodiments, to capture any such markings as they are being made. For example, a pen may be fitted with a wireless transmitter, using any suitable wireless technologies, e.g., Bluetooth, 802.11a, b, g, etc.

At 120 any data that had been captured in 110 is interpreted through an interpretation engine. The interpretation comprises recognition of the markings downloaded to the system. In this and other preferred embodiments, the form is divided into regions, and interpretation, comprised of a recognition engine, has been preloaded with specific data types that will be found within those regions. For example, a region might call for one or more telephone number fields, and so the recognition engine will apply a telephone number type recognition algorithm that should provide more accurate recognition than a general recognition algorithm.

The interpretation process is also responsible, in this and other preferred algorithms, for feeding recognized data into the system, according to data types. Once the data is recognized, fields in data records will be populated as per their recognition, e.g., telephone number field or fields, etc.

Various embodiments may have different forms, and so interpretation may utilize form specific recognition engines. For example, a procedure form may provide for a telephone number region, as was described further above, and so the appropriate form specific regions with associated recognition engine would be utilized. As another example, a communication form may provide for an employee identification number so the appropriate form specific regions with appropriate recognition engine would be utilized. In other words, the recognition engine may utilize a template type construction, wherein form-specific templates are provided with their appropriate information type regions. When the type of form is recognized, the form-specific template is utilized by the recognition engine to overlay the appropriate, data specific regions, recognize those regions according to type of data, and feed the recognized data into the system for subsequent processing.

It should also be noted in various embodiments that interpretation of a form, and subsequent use of a form specific engine, may be done in various manners. For example, a field may be checked on the form, and subsequently passed to the interpretation engine, indicating type of form. As another example, the dot pattern on the form may be so placed as to indicate the type of form, so any marks made on the form will, in addition to being interpreted so as to conveying the marks and/or any information conveyed therein, also convey the form type. As yet another example, the recognition of form type, and specific form template, may await recognition of the data and its placement, that is, a procedure form would first be recognized in whole or part using a general template, interpretation would decide upon a form specific template to use based on that recognition, and a form specific template would then be used to further recognize and/or refine the recognition that has taken place.

130 shows an optional form definition process, which may be used to assist in interpretation. That is, certain areas on the form of this embodiment may have been predefined to assist in form interpretation and 130 may provide those predefined areas to the interpretation process 120.

Certain boxes on form 10 may be used to automatically, upon data collection from the form, initiate one or more functions automatically, that is, without further intervention. For example, tick boxes, fill-in areas, etc. may be used as desired for automatic function initiation.

Returning now to the embodiment of FIG. 3, the interpretation process should provide, when completed, a list of most likely data for various fields. For example, a list of most likely phone numbers, addresses, etc. The length of the list may vary, and in preferred embodiments the list is of the 10 most likely interpretations.

A Rules Verification phase is seen generally at C. Process 140 performs a data rules check. This data rules check ensures that the data, as taken from appropriate fields on the form, has been appropriately interpreted.

Various embodiments may use various types of data rules check. In these and other embodiments, categories of data rules checks may include:

Data type fill in. For example, a data rules check using a data type fill in may automatically verify and/or fill in an address based upon a zip code.

Data length fill in. For example, a data rules check using a data length fill in may verify and/or fill in fields based upon length definitions—that is a data entry, once interpreted will be examined for appropriate length.

Checking against a lexicon. A lexicon is provided in preferred embodiments. The lexicon contains predefined possible values for particular data values. For example, a state address field lexicon contains fifty state two-digit abbreviations. If, after interpretation, the field contains an unrecognized abbreviation, (e.g., PZ or PN) the data rules check against the lexicon would note that the abbreviation is not one of the fifty acceptable abbreviations contained within its lexicon. It will flag the entry for later review and/or correction by a (usually manual) reviewer.

Mathematical algorithm verification. For example, a data rules check using a mathematical algorithm may be used to verify numbers, etc. in order to confirm appropriate interpretation and/or flag for review.

Data type verification. For example, a data rules check may include a data type verification, such as a rule ensuring that, if one field is checked, ticked, etc. another field, which requires data has been filled out. It may be desired as well to perform checks before validation, in order to further review after recognition

Spell check verification. For example spell checking may be interposed by a data rules check.

A Validation by User Interface phase is seen generally at D. Here, process 150 first provides an electronic copy of the form, after interpretation and rules verification, to a user. Often, in various embodiments, this user will be off-site, such a laboratory technician or the like. The user reviews the image of the form as originally created and compares that image to a data entry form which has recognized information from the form. The user will also ensure that the form has passed interpretation and rules verification.

The user will make any corrections necessary to the data entry screen from the form image. In preferred embodiments, users may choose from a drop down list of possible corrections, ranked in order of possibility. Additionally, in various embodiments, a user field may be opened for a user to type corrections.

For example, regions supposed to be specific to a particular data type, e.g., patient name, may be incorrectly used, such as when markings overflow the region. This overflow may impede recognition, and so correction may be necessary. Of course, corrections may be made, and the system may learn, as a user proceeds. For example, a user's handwriting may be learned by the system so as to have less errors in recognition.

As was described above, for example, an interpretation phase may provide a number of preferred data possibilities. Upon choice of any particular data possibility, the learning system will note the choice. In various embodiments, the system will record the choice, and, if, appropriate, parse any specific characters, etc. in order to associate a pen stroke with the character. This learning—attaching a character to a pen stroke—should improve recognition.

Additionally, embodiments may associate entire “blocks” of images, such as words, number sequences, etc. so as improve recognition as well.

Any such images and associated characters may be used in various manners. For example, a typical embodiment has associated with its interpretation phase one or more images of a character—e.g., three separate possible strokes for an “A”. Through a learning phase in various embodiments, a new image may be associated with an “A” which may be more specific to a user (that is, the person filling out the form.)

Error messages may be generated for a user where markings are ambiguous. For example, if markings within a test block are unclear, an error message may be generated so as to indicate that instructions are unclear.

If necessary, the user may contact the original physician's office to verify information and/or modify information. Such may be done as desired. For example, an embodiment may manually or automatically open an email window to the appropriate physician upon signaling of an error, ambiguity, etc.; a phone number may be manually or automatically dialed, an email and/or instant message may be sent, a Voice-Over-IP connection made, etc. In preferred embodiments, an audit trail is created of modifications made by the user.

If appropriate the user will pass the form on to processing as is further described below (160.) If the form has not passed interpretation and/or verification, the user will place the form on hold (170.) The user may also choose to record any comments regarding the issues and/or reasons for placing the form on hold, such as interpreted data issues, etc. It may be desired to provide a reminder, sorting ability (by fields, e.g., client, user, data, category, etc.) In various embodiments, forms will remain on hold until released, and reminders will continue to be sent.

Once the recognized data has passed through the Verification By User Interface phase, it is sent to a legacy system, which here is a lab information system 190. In various embodiments, this is a legacy system already in place, as are known in the art. The process shown in FIG. 3, therefore, is responsible for placing the recognized data at an appropriate interface so as to provide appropriate data for the tests as have been ordered, etc. Of course, other embodiments may have a different sequence of phases, modified phases, different phases, etc.

Various embodiments provide for scheduling and other actions based on the data provided. For example, a lab may be obtaining electronic copies of forms throughout the day, from one or more physician's offices, rather than a simple batch shipment of paper as might otherwise occur. Thus, a dedicated user may be assigned to review the forms as they arrive, simplifying workflow when compared to batch processing of a number of paper forms received at one time. As another example, a laboratory may be able to schedule its workflow, according to physician's requests, on an ongoing basis rather than waiting for a group of paper forms to arrive, providing flexibility and tailoring of resources to workflow. As yet another example, errors, which may result in needing more communication with a physician's office, may be corrected as they arise, by contacting the physician's office as soon as the errors arise, rather than waiting for batch receipts of paper forms, review of all forms received, etc.

Moreover, data may be used, modified, etc. For example, testing data may be easily bundled, records kept of workflow through work shift, etc. Additional data may be added as well at any point in the process. For example, physician and/or patient identification data may be added, reports generated, etc. One embodiment comprises providing to practitioners a regular report on use of various lab tests. Another embodiment comprises pen registration, that is, having a pen be registered to a specific user and/or practitioner, by a identification code. For example, a code may be added to forms as they are filled out by a physician's office in order to track all forms, data, etc. to that office. As another example, data may in turn trigger another event, such as another screen with physician information, a link to another system, etc. As yet another example, data may be copied and/or split, that is, some data resulting from a form may be provided to a first data user, other data and/or copies of the same data may be provided to a second data user, etc.

Embodiments may be provided that utilize intelligent forms. For example, if a patient is identified as having a particular condition, standard tests are often used. If a form indicates a condition without standard tests, a query may be initiated to confirm the tests to be performed. “Prompting” which is regulated by health insurance and the like, should be avoided in any such embodiments.

Various embodiments may combine and/or separate various components and/or phases. For example, a pen may include a data capture device and wireless transmitter, so that little or no interaction is necessary from an individual who is filling out forms.

Various embodiments may utilize various types of paper. For example, a multipart form (such as one using NCR-type paper) with detachable identification (such a peelable bar code sticker keyed to a numbered id on the form) may be used when originally filling out the form. One of the paper copies of the form may then be transmitted with a specimen, as may be required by various regulations. The bar code is peeled and placed directly on the specimen. Thus a paper copy is transmitted with the specimen, which is then identifiable by bar code as well. Any tests or other handling instructions for the specimen would then be available on both the paper copy accompanying the specimen, as well as on a data record after processing of the digital pen data. Simply scanning the bar code on the specimen would provide the data record if desired. This an similar embodiments may be used where a paper copy is necessary, e.g., ABN type tests, etc.

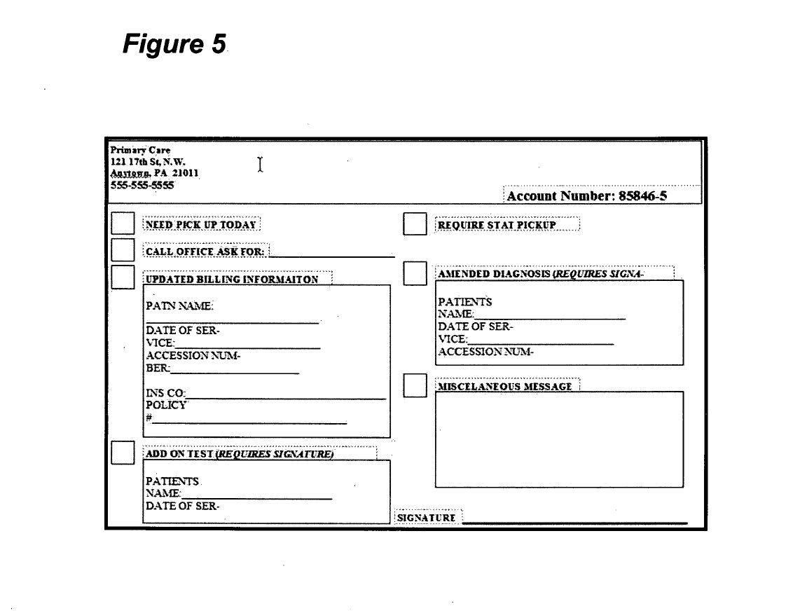

Other embodiments may initiate and/or continue asynchronous communication(s.) For example, turning to FIG. 5, a communications embodiment is shown. Form 11 is used to provide information that is meant to be transmitted to another user and/or system. In this and other embodiments, various phases, described above, may be modified and or dispensed with. So, for example, an intra-office embodiments may not require validation, data rules, etc. As another example, add-on tests, patient specific information, etc. may use validation.

The form and/or data regions used on the form may provide for specific data treatment. So, for example, certain areas on a form may determine subsequent data processing, verification, rules application, etc. for that form and./or data region.

Custom forms may also be used in various embodiments. For example, a particular physician practice may be provided with a particular practice-specific form, while another, different practice may be provided with another practice specific form. This may provide a receiving lab with the ability to provide a physician and/or practice customized form fairly inexpensively. Customized forms may also be created and/or modified as they are used, for example, a form may be developed as it is used in order to better reflect particular physician operations, etc. As the form is used, records are kept of the use of various fields, and so the form may be redesigned based on use.

Forms may be supplied to a user—e.g., preprinted, etc. or, in various embodiments, the template may be available for downloading, printing and subsequent use by a physician's office.

The above description and the views and material depicted by the figures are for purposes of illustration only and are not intended to be, and should not be construed as, limitations on the disclosure. Moreover, certain modifications or alternatives may suggest themselves to those skilled in the art upon reading of this specification, all of which are intended to be within the spirit and scope of the present disclosure as defined in the attached claims.

We claim:

1. A digital pen system for use in healthcare comprising:
a digital pen;
a form, compatible with said digital pen;
a data capture device for said pen for receiving any data generated by use of said pen on said form;
an interpretation engine wherein any of said data captured by said data capture device is interpreted thereby providing interpreted data;
a user interface for reviewing said interpreted data, and also for comparing said interpreted data against an electronic image of said form.

2. A digital pen system as in claim 1 wherein said user may modify, through said user interface, any of said interpreted data.

3. A digital pen system as in claim 1 wherein said user may comment upon, through said user interface, any of said interpreted data.

4. A digital pen system as in claim 1 further comprising an interface to a legacy system which receives any interpreted data.

5. A digital pen system as in claim 1 further comprising a rules engine which applies data rules to any of said interpreted data.

6. A digital pen system as in claim 1 with said form further comprising a preprinted form.

7. A digital pen system as in claim 1 with said form further comprising a preprinted form.

8. A digital pen system as in claim 1 with said form being selected from the group consisting of: diagnostic services, laboratory services, radiology services, ultrasound services, pharmacy services, pathology services, ABN, inter-office and intra-office communications.

9. A digital pen system as in claim 1 with said form comprised of regions.

10. A digital pen system as in claim 1 where said data capture device further comprises a dock.

11. A digital pen system as in claim 1 where said digital pen further comprises a wireless digital pen.

12. A digital pen system as in claim 1 where said interpretation engine comprises a recognition engine.

13. A digital pen system as in claim 1 where said interpretation engine comprises form specific recognition engines.

14. A process for capturing information generated through a digital pen in healthcare, comprising:
acquiring data generated by a digital pen on a form;
interpreting said data;
verifying said data through applying data rules;
validating said data, by comparison of said data with an electronic copy of said form, though a user interface.

15. A process as in claim 14 further comprising providing said data to a legacy interface.

16. A process as in claim 14 further comprising providing a rules engine which applies data rules to any of said interpreted data.

17. A process as in claim 14 with said form further comprising a preprinted form.

18. A process as in claim 14 with said form further comprising a preprinted form.

19. A process as in claim 14 with said form being selected from the group consisting of: diagnostic services, laboratory services, radiology services, ultrasound services, pharmacy services, pathology services, ABN, inter-office and intra-office communications.

20. A process as in claim 14 with said form comprised of regions.

21. A process as in claim 14 where acquiring data generated by a digital pen on a form further comprises acquiring data through a dock.

22. A process as in claim 14 where acquiring data generated by a digital pen on a form further comprises acquiring data through a wireless digital pen.

23. A process as in claim 14 where interpreting said data further comprises interpreting said data using a recognition engine.

24. A process as in claim 14 where interpreting said data further comprises interpreting said data using form specific recognition engines.

25. A process as in claim 14 further comprising a form definition process.

26. A process as in claim 14 further comprising automatic initiation of functions.

27. A process as in claim 14 further comprising attaching a character to a pen stroke.

28. A process as in claim 14 further comprising generating an error message.

29. A process as in claim 14 further comprising verifying data.

30. A process as in claim 14 further comprising placing said form on hold.

31. A process as in claim 14 further comprising placing said form on hold with comments.

32. A process as in claim 14 further comprising initiating a query.

33. A process as in claim 14 further comprising utilizing a form with bar code.

34. A process as in claim 14 further comprising utilizing a practice specific form.
